(19) United States
(12) Patent Application Publication
(10) Pub. No.: US 2009/0007081 A1
(43) Pub. Date: Jan. 1, 2009

(54) System and Method of Generating Applications for Mobile Devices

(76) Inventors: Allen N.L. Lau, Markham (CA); Jake Phillips, Toronto (CA); Oliver Attila Tabay, Toronto (CA); Ion-Dan Calinescu, Toronto (CA)

Correspondence Address: BERESKIN AND PARR, 40 KING STREET WEST, BOX 401, TORONTO, ON, M5H 3Y2, CA

(21) Appl. No.: 12/159,018

(22) PCT Filed: May 23, 2007
(86) PCT No.: PCT/CA07/00911

§ 371 Date: Jun. 24, 2008

Related U.S. Application Data
(60) Provisional application No. 60/808,540, filed on May 26, 2006.

(51) Int. Cl. G06F 9/445; G06F 9/44

(52) U.S. Cl. 717/136

(57) ABSTRACT

A system and method for transforming a reference application written for a reference mobile device into a target application for a target mobile device is disclosed. The system includes: a) transforms and metadata associated with each transform, where the transform includes instructions to modify a portion of the reference application and the metadata includes at least one of device-specific information and application-specific information; b) a plug-in containing links to a selected portion of the transforms, where the selected portion of the transforms is selected using the metadata; and c) a transformation engine which communicates with the with the plug-in to execute the instructions in each of the transforms in the selected portion.

### FIELD OF THE INVENTION

The invention relates to automated application development. In particular, the invention relates to systems and methods for transforming an application written for one particular mobile device to run optimally on other mobile devices.

### BACKGROUND OF THE INVENTION

The popularity of mobile devices, such as wireless phones, pagers, and personal digital assistants (PDAs) continues to increase. As more and more people acquire mobile devices, the number of different types of devices available have also increased, as well as the capabilities of such devices. Many of these mobile devices are customized using application programs which run on these devices. Examples of application programs available on mobile devices include games, mail programs, and contact management applications.

Application programs are written for a particular device architecture (and associated instruction set), as well as a particular operating system, which is supported by the architecture. Application programs written for a combination of one particular architecture and operating system may not execute optimally or at all on a different architecture and/or different operating system. This is either due to the fact that the instruction sets and/or the interface to the libraries of the different architectures and operating systems are different and/or due to the fact that there are device constraints/differences such as display size. For this reason, applications that are developed to run on one type of mobile device with a particular architecture operating system combination may not run (or not run optimally) on another type of mobile device with a different operating system architecture combination. For example, applications which run on Nokia™ devices typically do not run on Motorola™ devices, even when both of these devices support Java.

Several methods to transform (also referred to as “migrate” in the art) an application from an architecture operating system combination for one mobile device to a different architecture operating system combination for a target mobile device are known.

One such method is the so-called “porting approach”. With the porting approach the software developer takes the source code for the application program to be converted and runs the source code through a compiler developed for the target mobile device.

One disadvantage of porting is that a relatively large amount of time is required to port an application program to the target mobile device. In addition, porting requires significant human intervention, as it is almost certain that the source code has to be modified before it can be compiled and executed properly on the target mobile device.

Another known method is referred to as the “on-line interpretation” approach. In this method, a software module called an “interpreter” interprets instructions from an executable version of the application program written to run on the first mobile device. The interpreter chooses the appropriate instructions or routines required for the application to execute the same functions in the target mobile device. The interpreter essentially runs as an emulator, which responds to an executable file of the application which runs on the first mobile device, and in turn, creates a converted executable file which runs on the target mobile device.

A disadvantage of the on-line interpretation method is that the interpreter must be able to be loaded and executed on the target mobile device. While this is possible on some systems like desktop personal computer systems, it is not feasible for mobile devices due to size and performance limitations.

Accordingly, there is a need for systems and methods for more quickly and efficiently transforming applications from a reference application to run or run optimally on different types of mobile devices.

### SUMMARY OF THE INVENTION

According to a first aspect of the invention, a method of transforming a reference application configured to execute on a reference mobile device into a target application configured to execute on a target mobile device is provided. The method comprises:

a) providing a plurality of transforms and metadata associated with each of the plurality of transforms, wherein the plurality of transforms comprise instructions to modify a portion of the reference application, the metadata comprising at least one of device-specific information and application-specific information; and

b) executing the instructions from a selected portion of the plurality of transforms, wherein the selected portion of the plurality of transforms is selected based on the metadata.

Preferably, the method further comprises providing a plurality of links stored in a plug-in, where each of the links points to a corresponding transform.

According to a second aspect of the invention, a system for transforming a reference application adapted to execute on a reference mobile device into a target application configured to execute on a target mobile device is provided. The system comprising:

a) a plurality of transforms and metadata associated with each of the plurality of transforms, wherein each of the plurality of transforms comprise instructions to modify a portion of the reference application, the metadata comprising at least one of device-specific information and application-specific information;

b) a plug-in adapted to access a selected portion of the plurality of transforms, wherein the selected portion of the plurality of transforms is selected using the metadata; and

c) a transformation engine adapted to communicate with the with the plug-in in order to execute the instructions in each of the selected portion of the plurality of transforms.

According to a third aspect of the invention, a computer readable medium having instructions recorded thereon, for execution by a computer, for transforming a reference application configured to execute on a reference mobile device into a target application configured to execute on a target mobile device, the instructions comprising:

a) providing a plurality of transforms and metadata associated with each of the plurality of transforms, wherein the plurality of transforms comprise instructions to modify a portion of the reference application, the metadata comprising at least one of device-specific information and application-specific information; and

b) executing the instructions from a selected portion of the plurality of transforms, wherein the selected portion of the plurality of transforms is selected based on the metadata.

### BRIEF DESCRIPTION OF THE DRAWINGS

In the accompanying drawings:

FIG. 1 is a block diagram of a first embodiment of a system of generating applications for mobile devices according to the present invention; and

FIG. 2 is a flow chart illustrating the method according to an embodiment of the present invention.

### DETAILED DESCRIPTION OF THE PREFERRED EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

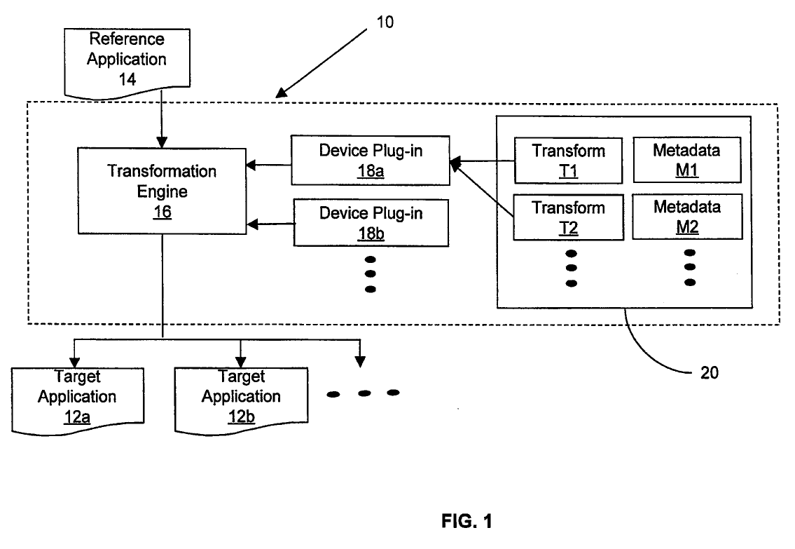

FIG. 1 shows a system 10 for generating any suitable number of target applications 12a, 12b from a reference application 14, according to a first embodiment of the present invention. For clarity, only two target applications 12a and 12b are shown.

The reference application 14 is written to execute on one type of mobile device. The reference application may be written in the Java™ programming language written for Java 2 Platform, Micro Edition (J2ME) standard, in C++ for Binary Runtime Environment for Wireless (BREW), or in any other programming language capable of being executed on a mobile device. The mobile device on which the reference application is written will be referred to herein as a reference mobile device (not shown).

As used herein, a “mobile device” may be any portable computing device, such as a wireless, cellular, or satellite telephone, pager, Personal Digital Assistant (PDA), set-top box, or an in-vehicle telematic system.

Continuing to refer to FIG. 1, the system 10 includes a transformation engine 16. The transformation engine 16 is a software module which runs on any suitable computer, such as, for example, a personal computer. The transformation engine 16 is preferably a Java application that may be configured to run on a desktop personal computer or a server, although it will be understood by those skilled in the art that the transformation engine may be written in any suitable language. The transformation engine 16 is further described in a commonly assigned co-pending US application published under No. US 2005-0108692 A1, which is incorporated herein in its entirety.

The system 10 also includes any suitable numbers of device plug-ins which are preferably stored in the computer memory and which may be accessed by the transformation engine 16. For clarity, two device plug-ins 18a and 18b, are shown in FIG. 1. Each device plug-in 18a, 18b is capable of transforming the reference application 14 for a specific combination of a reference mobile device and a target mobile device. As used herein, a “target mobile device” is any mobile device which does not support the reference application 14. Typically, the target mobile device either has a different architecture and/or a different operating system or different device characteristics (e.g. display size, font size, API's etc.) from the reference mobile device. The target mobile device does not “support” the reference application 14 when the reference application 14 does not execute on the target device, or when the reference application is not optimized for execution on the target mobile device. Examples of a lack of optimization may include executing slowly or not rendering graphics correctly on the target mobile device.

For example, the reference device may be a Nokia™ Series 40 cellular phone, and the target devices may be a Samsung™ S300, a Motorola™ T720, and a Sharp™ GX10 cellular phone. In this example, device plug-in 18a corresponds to the combination of Nokia™ Series 40 and Samsung™ S300 phones. Device plug-in 18b corresponds to the combination of Nokia™ Series 40 and Motorola™ T720 phones. Target application 12a generated by device plug-in 18a is optimized for a Samsung™ S300 phone. Target application 12b generated by device plug-in 18b is optimized for a Nokia™ Series 40 phone.

The target applications 12a, 12b are generated by modifying the reference application 14, as described in detail below. The target applications 12a, 12b may be Java applications if the target mobile device supports Java. Alternatively, the target applications may be any other type of application supported by a particular target mobile device, such as BREW™ or Symbian™.

Preferably, each device plug-in 18a, 18b contains any suitable number of links or mappings (collectively referred to herein as “links”), wherein each link or mapping points to a corresponding transform. For clarity, only two transforms T1, T2 are shown in FIG. 1. However, it will be understood by those skilled in the art any suitable number of transforms may be provided. The transforms T1, T2 are preferably stored in any suitable storage 20, such as an Oracle™ relational database. Alternatively, the entire transform may be copied into the device plug-in 18a, 18b, in which case the links and mappings may not need be used.

Preferably metadata M1, M2 relating to transforms T1, T2, respectively are also stored in storage 20. For clarity, only transforms linked to device plug-in 18a, as well as their corresponding metadata, are shown in FIG. 1. Device plug-in 18b is similarly linked to one or more transforms which may have corresponding metadata.

In one embodiment, the transforms T1, T2 stored in storage 20 may be available may be linked via a network, such as the Internet, to many different instances of plug-ins operating with many different transformation engines. In another embodiment, the transforms may not all be stored in a single storage 20, but may be distributed in any number of storages linked by a network, such as the Internet.

In another embodiment, software developers and various other users may create their own transforms and upload them to storage 20 via a network, or otherwise make them available to users of the system 10. The transforms may be open transforms such that subsequent users may test and modify the transforms, or their associated metadata in order to improve the transforms or improve the information available about the transforms.

The transforms T1, T2 are preferably scripts which contain a list of instructions to the transformation engine 16 to modify the reference application 14. The transforms T1, T2 may modify the source code of the reference application 14 or the bytecode (if the reference application is a Java application). The content of the transforms T1, T2 are based on a collection of differences in the characteristics between the reference mobile device and the target mobile device. Typical device characteristics where such differences may be present include without limitation: memory, processing speed, key mapping, screen size, font size, image/sound file format differences, device-specific Java API calls, and non-standard behavior of standard Java API calls. Some examples of the types of instructions that may be included in the transforms T1, T2, are as follows:

1. Modify a method call, as follows:
a. insert code before the method call;
b. insert code after the method call;
c. replace the method call (includes removing the entire method call);
d. modify the parameters of the method call; and
e. modify the return value of the method call.
   2. Modify a method/constructor, as follows:
a. insert code at the beginning of the method/constructor;
b. insert code at the end of the method/constructor;
c. modify the method/constructor body;
d. add a try/catch block of the entire method/constructor body; and
e. rename the method (not applicable to constructor).
   3. Modify a “new” expression, as follows:
a. insert code before the “new” call;
b. insert code after the “new” call;
c. replace the “new” call;
d. modify the parameters of the “new” call; and
e. modify the return value of the “new” call.
   4. Modify an exception handler, as follows:
a. insert before an exception handler.
   5. Modify a field access, as follows:
a. insert code before the field access;
b. insert code after the field access;
c. replace the field access (includes removing the entire field access); and
d. modify the return value of the field access.
   6. Add a new method to a class file, as follows:
a. insert the new method info in the class file method list;
b. insert the method name and type in the class file constant pool;
c. insert the body of the source method in the class file;
d. adjust the newly inserted method body with the class file context (validate branch instruction targets and instruction length).
   7. Rename an existing method in a class file, as follows:
a. find the method definition in the constant pool; and
b. rename the method's name entry in the constant pool.
   8. Replace the method call of a particular object [e.g. “o1.method1(arg1, arg2 . . . argn)”] with a method call of another object in a class file [e.g. “o2.method2(arg1, arg2 . . . argn)”], as follows:
a. search all the references of the o1.method1 call in the class file; and
b. replace the references with o2.method2.
   9. Replace an original method call [e.g. “o1.method1(arg1, arg2 . . . argn)”] with a static method call [e.g. “static o2.method2(o1, arg1, arg2 . . . argn)”] in a class file, as follows:
a. search all the references of the o1.method1 call in the class file; and
b. replace the references with o2.method2.
   10. Rename constant pool entries in a class file, as follows:
a. search for the constant pool entry; and
b. rename it.
   11. Insert a new class file, as follows:
a. add the reference of the inner class to the target class file; and
b. copy the compiled inner class to the target class file.

According to one embodiment, each of the transforms T1, T2 may be assigned to a particular domain. For example, the domains may govern the level of access to transforms in that domain. In addition, the domain of the transform may indicate a level of trust assigned to the domain.

In an exemplary embodiment, each transform may be assigned to one of four domains. The first domain my be a TRUSTED domain. The transforms assigned to the TRUSTED domain may be tested by the operator of the system 10. The operator may be an organization specializing in transforming applications for different target mobile devices (commonly referred to as “porting services provider”). In the subject embodiment, The operator possesses the most expertise in porting and would be in the best position in evaluating the effectiveness of various transforms. The set of transforms assigned to the TRUSTED domain are preferably available to all users of the transforms.

Another set of transforms may be assigned to a GLOBAL domain. The transforms in the GLOBAL domain may also be available to all users. However, the level of trust for the GLOBAL domain may be lower than the transforms assigned to the TRUSTED domain. For example, the transforms in the GLOBAL domain may not be tested by the porting services provider, and their effectiveness may not be proven.

A third set of transforms may be assigned to an INTERNAL domain. The transforms assigned to the INTERNAL domain are available only to users which belong to a particular organization. In one embodiment, such an organization may be a licensee of the software which implements the system 10.

A fourth set of transforms may be assigned to a LOCAL domain which are available only to a particular work station.

In other words, users from all organizations which use the system 10 will have access to those transforms in the TRUSTED and GLOBAL domains. The transforms in the INTERNAL domain may be accessible only to the organization that created such transforms, and transforms in the LOCAL domain may be accessible only to the individual user/employees of the organization. Consequently, there will only be one TRUSTED and one GLOBAL domain for the community of users of the transforms. However, there may be many INTERNAL domains and many LOCAL domains which are only accessible to subsets of the community of users. Users may upload the transforms from their INTERNAL and LOCAL domain to the GLOBAL domain. Preferably, only the porting services provider who licenses the system 10 has authority to promote transforms to the TRUSTED domain. Such promotion may be based, in one embodiment, on testing of the transforms.

Continuing to refer to FIG. 1, the metadata M1, M2 may include without limitation the following information:

| Name | Description |
|---|---|
| Name | Name of the transform |
| Description | Description of transform |
| Code keywords | Keywords found in code |
| Category | Category that the transform resides in (may be |
| | multiple) |
| Times Used | Times this transform was used |
| Devices used on | The devices this transform was used on |
| User Rating | The user rating of the transform (/5) |
| Relates To | Defines a flavour relation |
| Executes | Defines the other transforms that this transform |
| | executes |
| External Libraries | Defines the 3^{rd} party libraries this transform uses |
| | (and whether they are flagged distributable or URL- |
| | based) |
| Depends On | Defines a loose inheritance model (must merge the |
| | depends on transforms before execution) |
| Required Context | The context(s) that this transform can work on |
| Must be Customized | Denotes a transform that must be further |
| | customized to properly work (will not work out of |
| | the box) |
| Searchable | Whether this transform is available to the indexing |
| | service |

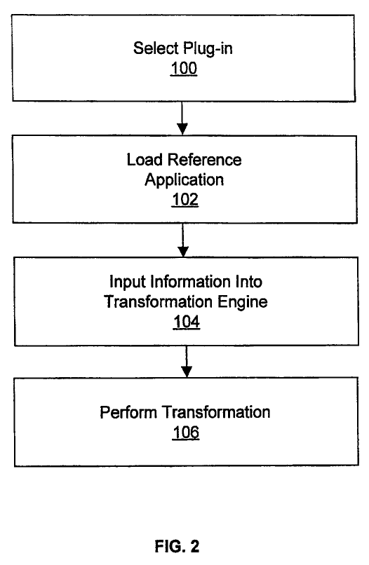

The operation of the exemplary embodiment of the present invention will now be described with reference to FIGS. 1 and 2.

The operation begins at step 100 by the user selecting one of the plug-ins 18a, 18b which corresponds to the desired reference/target mobile device combination. The selected plug-in may already include a group of links to a portion of the needed transforms T1, T2. The included transforms may be the default transforms necessary for any application to be transformed into a target application for the selected reference/target mobile device combination. Alternatively, the selected plug-in may be empty. Whether the plug-in is empty or not, the user may add links to selected transforms which will transform the reference application 14 into a target application for a particular device combination. For example, the user may add transforms which are address application-specific issues or other issues which are specific to particular device functionality accessed by the application (such as for example sounds).

The user may use the metadata M1, M2 associated with the transforms T1, T2 to decide whether a particular transform may be beneficial. In another embodiment, the system 10 may include search engine functionality to permit the user to search all of the transforms in the domains to which the user has access. The search criteria may look for device-specific or application-specific criteria relevant to the particular transformation. The search results may assist the user in populating the selected plug-in with the links to the appropriate transforms. The ranking of the search results may be based on any suitable criteria, such as usage and developer ratings or reviews. Depending on the transforms selected, the order of execution of the linked transforms included in the plug-in may or may not be important. Information relating to order of execution may be available in the metadata for the selected transforms. If order is important for certain transforms, the user would order the links accordingly.

Continuing to refer to FIGS. 1 and 2, the reference application 14 is loaded into the memory of the computer at step 102. At step 104, the identities of reference mobile device and the chosen target mobile device are then input into the transformation engine 16. In addition, an output directory for the target application 12 is input into the transformation engine 16.

At step 106, the transformation engine 16 selects one of the device plug-ins 18a, 18b which corresponds to the inputted combination of reference and target mobile device. For example, if the selected reference mobile device is the Nokia™ Series 40 wireless phone and the target mobile device is the Samsung™ S300 wireless phone, device plug-in 18a is selected.

The transformation engine 16 performs the transformation by accessing the first link listed in the plug-in 18a to the corresponding transform T1 and executing the instructions in the transform. The transformation engine 16 repeats the same step for transform T2 and all subsequent links listed in the plug-in.

If the reference application is a Java application and the transformations are at the byte code level, the target application may be repackaged. If the transformation took place at the source code level (whether the application was written in Java or another programming language), the target application may be compiled into executable code.

A different target application may be created from the reference application 14, by selecting a different device plug-in associated with a different device combination. The plug-in may be populated with links to transforms in the same manner as described above.

A second different reference application (not shown) may be selected for transformation for the same device combination. In this case, the process must be repeated for the second reference application using the same plug-in. The plug-in may be left unchanged, or links may be removed or added in order to add transforms which may be more suitable to the different reference application. The decision to add or remove links to transforms may be based on application-specific metadata associated with such transforms.

In this manner, many different reference applications may be transformed into corresponding target applications for a particular combination of a reference and target mobile device using a single device plug-in (such as device plug-in 18a for the Nokia™ Series 40/Samsung™ S300 wireless telephone combination).

In the above example, the device plug-in 18a may be used to automatically transform a variety of different reference applications (such as different games) which run on the Nokia™ Series 40 phones into corresponding target applications for the Samsung™ S300 phones. This provides the advantage of allowing developers to reduce development time by only having to write an application for a single reference device. The embodiment of the present invention described herein automates the process of migrating the reference application to target devices which may not otherwise support the reference application, thereby greatly reducing the development time required to migrate the applications, as well as reducing the time and expense required to manage and maintain multiple versions of source code.

A target application generated from one transformation may then be used as the reference application for a future transformation, which is conducted in accordance with the systems and methods discussed above.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A method of transforming a reference application configured to execute on a reference mobile device into a target application configured to execute on a target mobile device, the method comprising:
a) providing a plurality of transforms and metadata associated with each of the plurality of transforms, wherein the plurality of transforms comprise instructions to modify a portion of the reference application, the metadata comprising at least one of device-specific information and application-specific information; and
b) executing the instructions from a selected portion of the plurality of transforms, wherein the selected portion of the plurality of transforms is selected based on the metadata.

2. The method of claim 1, further comprising providing a plurality of links stored in a plug-in, wherein each of the plurality of links points to a corresponding one of the selected portion of the plurality of transforms.

3. The method of claim 2, further comprising selecting the selected portion of the plurality of transforms using the metadata associated with each transform.

4. The method of claim 3, further comprising populating the plug-in with at least a portion of the plurality of links.

5. The method of claim 4, further comprising searching the metadata using a search engine.

6. The method of claim 5, further comprising assigning a domain to the plurality of transforms.

7. The method of claim 5, wherein the domain is selected from the group comprising: TRUSTED, GLOBAL, INTERNAL, and LOCAL.

8. The method of claim 6, wherein the executing step further comprises a transformation engine accessing the plurality of links stored in the plug-in.

9. The method of claim 8, wherein the reference application is written in the Java™ programming language and wherein the executing step comprises modifying the reference application at a byte code level.

10. A system for transforming a reference application adapted to execute on a reference mobile device into a target application configured to execute on a target mobile device, the system comprising:
a) a plurality of transforms and metadata associated with each of the plurality of transforms, wherein each of the plurality of transforms comprise instructions to modify a portion of the reference application, the metadata comprising at least one of device-specific information and application-specific information;
b) a plug-in adapted to access a selected portion of the plurality of transforms, wherein the selected portion of the plurality of transforms is selected using the metadata; and
c) a transformation engine adapted to communicate with the with the plug-in in order to execute the instructions in each of the selected portion of the plurality of transforms.

11. The system of claim 10, wherein the plug-in comprises a plurality of links, wherein each of the link points to a corresponding one of the selected portion of the plurality of transforms.

12. The system of claim 11, wherein a domain is assigned to each of the plurality of transforms.

13. The system of claim 12, wherein the domain is selected from the group comprising: TRUSTED, GLOBAL, INTERNAL, and LOCAL.

14. The system of claim 13, wherein the transformation engine is adapted to modify the reference application at a byte code level.

15. A computer readable medium having instructions recorded thereon, for execution by a computer, for transforming a reference application configured to execute on a reference mobile device into a target application configured to execute on a target mobile device, the instructions comprising:
a) providing a plurality of transforms and metadata associated with each of the plurality of transforms, wherein the plurality of transforms comprise instructions to modify a portion of the reference application, the metadata comprising at least one of device-specific information and application-specific information; and
b) executing the instructions from a selected portion of the plurality of transforms, wherein the selected portion of the plurality of transforms is selected based on the metadata.

16. The computer readable medium of claim 15, further comprises providing a plurality of links stored in a plug-in, wherein each of the plurality of links points to a corresponding one of the selected portion of the plurality of transforms.

17. The computer readable medium of claim 16, further comprising selecting the selected portion of the plurality of transforms using the metadata associated with each transform.

18. The computer readable medium of claim 17, further comprising populating the plug-in with at least a portion of the plurality of links.

19. The computer readable medium of claim 18, further comprising searching the metadata using a search engine.

20. The computer readable medium of claim 19, further comprising assigning a domain to the portion of the plurality of transforms.

21. The computer readable medium of claim 20, wherein the domain is selected from the group comprising: TRUSTED, GLOBAL, INTERNAL, and LOCAL.

22. The computer readable medium of claim 21, wherein the executing step further comprises a transformation engine accessing the plurality of links stored in the plug-in.

23. The computer readable medium of claim 22, wherein the reference application is written in the Java™ programming language and wherein the executing step comprises modifying the reference application at a byte code level.
